(19) United States
(12) Patent Application Publication
(10) Pub. No.: US 2025/0342753 A1
(43) Pub. Date: Nov. 6, 2025

(54) SYSTEM, METHOD, AND GAMING MACHINE FOR PLAYING ELECTRONIC CARD GAMES

(71) Applicant: Double D Holdco, LLC, Reno, NV (US)

(72) Inventors: Daniel deWaal, Reno, NV (US); Ciprian Pop, Reno, NV (US)

(21) Appl. No.: 19/200,541

(22) Filed: May 6, 2025

Related U.S. Application Data
(60) Provisional application No. 63/643,333, filed on May 6, 2024.

(51) Int. Cl. G07F 17/32

(52) U.S. Cl. CPC G07F 17/3293; G07F 17/3211

(57) ABSTRACT

A system, method, and gaming machine includes a plurality of electronic cards and having a Random Number Generator (RNG), wherein a controller includes a processor to execute an algorithm of instructions to receive the input from at least one input device, presenting a predetermined number of the electronic cards in a 13-card suit-less card deck, receive an input from the at least one input device for an amount of credits and decreasing the amount of credits from a credit meter, receive a selection of one of the predetermined number of the electronic cards from the at least one input device, reveal all of the predetermined number of the electronic cards, and if a special electronic card or other winning outcome was selected, display by the win meter an award amount and crediting the credit meter with the award amount.

### CROSS-REFERENCE TO RELATED APPLICATION(S)

This application claims priority to and the benefit of U.S. Provisional Patent Application Ser. No. 63/643,333, filed May 6, 2024, the disclosure of which is hereby incorporated by reference in its entirety for all purposes.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### BACKGROUND OF THE INVENTION

It is known to provide electronic card games such as video card games for playing games such as blackjack, baccarat, pai gow, poker, etc. In a typical video electronic card game, there are multiple cards dealt to allow a player to have a hand for the game. The player may choose to discard one or more cards and have dealt new cards to reveal a winning hand.

Video card games are popular forms of entertainment that allow players to place bets on the outcome of card selections from a deck of cards. Some examples of video card games are video poker, video blackjack, and video baccarat. However, existing video card games have rules or odds that limit support scalable large awards. For instance, video poker games typically use a standard 52-card deck and have fixed pay tables for different poker hands with the maximum award being driven by the hit frequency of a Royal Flush. Video blackjack and video baccarat games are based on the rules of traditional table games and similarly have limited options for large jackpots having to rely instead on side bets to drive larger jackpots.

### SUMMARY OF THE INVENTION

The present invention provides a system, method, and gaming machine to play new skill-based electronic card games that use a new 13-card suit-less deck of cards to provide players with awards or credits in a skill-based game.

The present invention also provides a system, method, and gaming machine having a game display configured to display a plurality of electronic cards of the electronic card game, at least one input device to provide an input, a credit meter, and a win meter, a controller programed to display, on the game display, the electronic cards, and having a Random Number Generator (RNG), wherein the RNG calls are limited to a predetermined number of the electronic cards in a 13-card suit-less card deck, and wherein the controller includes a processor to execute an algorithm of instructions to receive the input from the at least one input device, present a predetermined number of the electronic cards on the game display, the predetermined number of electronic cards being determined by the RNG, receive an input from the at least one input device for an amount of credits and decrease the amount of credits from a credit meter, receive a selection of one of the predetermined number of the electronic cards from the at least one input device, reveal all of the predetermined number of the electronic cards on the game display, and if a special electronic card or other winning outcome was selected, display by the win meter an award amount and crediting the credit meter with the award amount.

One advantage of the present invention is that the system, method, and gaming machine may be applied to electronic card games to allow the player to pick a card and press reveal to play to win a hand. Another advantage of the present invention is that the system, method, and gaming machine allows for a card picking game with a 13-card suit-less deck. Yet another advantage of the present invention is that the system, method, and gaming machine reduces complexity, making games more accessible for casual players. Still another advantage of the present invention is that the system, method, and gaming machine eliminates traditional card-counting strategies and necessitates new tactics in adapted games, thereby introducing a potential advantage for skilled players. A further advantage of the present invention is that the system, method, and gaming machine has a smaller card pool that can increase the frequency of certain events or hands, heightening game excitement.

Other features and advantages of the invention will be readily appreciated as the same becomes better understood by reference to the following detailed description when considered in connection with the accompanying drawings.

### BRIEF DESCRIPTION OF THE DRAWINGS

FIG. 1 is a schematic representation of a system for an electronic card game illustrated on a gaming machine, according to an embodiment of the present invention.

FIG. 2 is an exemplary view of a screenshot of the electronic card game with a paytable that may be used with the system and gaming machine shown in FIG. 1, according to an embodiment of the present invention.

FIG. 3 is an exemplary view of a screenshot of the electronic card game with the a paytable that may be used with the system and gaming machine shown in FIG. 1, according to an embodiment of the present invention.

FIG. 4 is an exemplary view of a screenshot of the electronic card game with a paytable that may be used with the system and gaming machine shown in FIG. 1, according to an embodiment of the present invention.

FIGS. 5A-5D are exemplary views of a screenshot of the electronic card game with the example of the 13-Card Baccarat that may be used with the system and gaming machine shown in FIG. 1, according to an embodiment of the present invention.

FIGS. 6A-6D are exemplary views of a screenshot of the electronic card game with the example of an alternate 13-Card Baccarat that may be used with the system and gaming machine shown in FIG. 1, according to an embodiment of the present invention.

FIGS. 7A-7D are exemplary views of a screenshot of the electronic card game with the example of the 13-Card Blackjack that may be used with the system and gaming machine shown in FIG. 1, according to an embodiment of the present invention.

FIGS. 8A-8D are exemplary views of a screenshot of the electronic card game with the example of an alternate 13-Card Blackjack that may be used with the system and gaming machine shown in FIG. 1, according to an embodiment of the present invention.

FIGS. 9A and 9B are exemplary views of a screenshot of the electronic card game with the paytable and RTP that may be used with the system and gaming machine shown in FIG. 1, according to an embodiment of the present invention.

FIGS. 9C-9K are exemplary views of a screenshot of the electronic card game with Side Bets Offered that may be used with the system and gaming machine shown in FIG. 1, according to an embodiment of the present invention.

FIGS. 10A-10C is an exemplary view of a screenshot of the electronic card game with RTP, paytable for Run Bonus, and paytable for Alternate Baccarat that may be used with the system and gaming machine shown in FIG. 1, according to an embodiment of the present invention.

### DETAILED DESCRIPTION OF THE PREFERRED EMBODIMENT(S)

The exemplary embodiments herein relate to various systems and methods used in gaming applications. It should be understood that each of the methods and individual steps recited herein may be partially or wholly carried out in a variety of ways and/or systems, which may include, but are not limited to, an electronic gaming machine (“EGM”) or electronic game machine such as video game for use by one or more players, a multiplayer platform which may include a player interface such as a touchscreen display and involve physical or virtual game symbols, a home computer and/or portable computing device, such as a tablet computer or mobile phone capable of communicating with a network or over the Internet, global telecommunication network or world wide web.

It should further be understood that the present invention is directed to, among other things, methods of providing, conducting and resolving skill-based games that include a sequence of controlled and concrete events. Some of these events may involve communications between computing components, establishing the eligibility of such computing components based on location and game specific rules, indication preferences, placing credits, debiting and awarding credits stored in an account, the generation or interpretation of random data and results for one or more players, the application of randomly-generated data to predefined rules, the determination of credit outcomes in accordance with preset outcome determining criteria, and the notification of such outcomes. The generation of random data may be facilitated by computerized and/or physical implements, such as a random number generator (“RNG”) or credits/chips awarded. It should be appreciated that the present invention increases the efficiency of the processing for a processor in the system.

The gaming machine determines the skill level of the player based on the amount of points accumulated during an instance of the game and changes the award determination table based on the determined skill level of the player. For a low-skill player, the gaming machine may use an award determination table which assures minimum return to player (RTP) percentage to the player. For a high-skill player, the gaming machine may use a different award determination table which provides more chance for a larger award. By providing different award determination tables based on skill levels, the gaming machine a) assures the minimum RTP (%) for low-level skill players and b) provides a chance to win high prize for high-level skill players concurrently. As used herein, the term “Return to Player” describes a value indicating an amount of wagered funds that will be returned to players over a predefined period of time. For example, instance, a gaming machine having an RTP of 95% is expected to return $95 out of every $100 put in over a predefined period of time. For example, a gaming machine implementing a skill-based wagering game and selecting an award determination table based on the determined skill level of the player is described in U.S. patent application Ser. No. 15/261,775 to Hirai et al., filed Sep. 9, 2016, titled “Gaming Machine and Methods of Operating Gaming Machines to Provide Skill-Based Wagering Games to Players”, which is incorporated herein by reference in its entirety.

A selected embodiment of the present invention will now be explained with reference to the drawings. It will be apparent to those skilled in the art from this disclosure that the following description of the embodiment of the present invention is provided for illustration only and not for the purpose of limiting the present invention as defined by the appended claims and their equivalents.

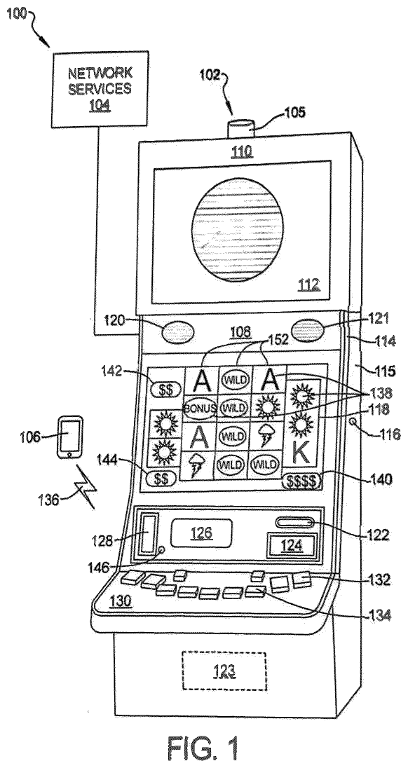

In general, gaming systems which provide electronic card-based games are described. In particular, with respect to FIG. 1, a gaming system 100 includes an electronic card-based gaming machine 102 such as an electronic card game video machine. The electronic card-based gaming machine 102 may include wireless or wired communication interfaces which allow communications with remote devices providing network services 104, such as, but not limited to, a player tracking system or a progressive gaming system. The player tracking system can be part of a game accounting system. In addition, the gaming machine 102 may include wireless communication interfaces, such as wireless interface 146, which allow communications with a nearby mobile device, such as a mobile phone 106 or tablet computer, via a wireless connection 136. It should be appreciated that the wireless interface 146 may employ wireless communication protocols, such as Bluetooth™ or Wi-Fi.

The mobile phone 106 or tablet computer can be utilized by a player or casino operator. A device carried by a player can be configured to perform gaming related functions, such as functions associated with transferring funds to or from the gaming machine 102 or functions related to player tracking. A device carried by a casino operator can be configured to perform operator related functions, such as performing hand payments, responding to tilt conditions or collecting metering related information.

The gaming machine 102 may include a cabinet 108 and a top box 110. The top box 110 is mounted above the cabinet 108. The top box 110 includes a display 112. The display 112 may be used to display video content, such as game art associated with the game played on the gaming machine 102. For example, the game art can include an electronic card deck or animated wheel. It should be appreciated that the animated wheel can be configured to spin and to stop revealing electronic cards for a bonus award. In other examples, the video content can include advertising and promotions.

In other embodiments, the top box 110 may include one or more mechanical devices in addition to the display or in lieu of the display. In yet other embodiments, the top box 110 may include a plurality of displays.

The cabinet 108 may include an entry door 114. In one embodiment, the door 114 swings outward and is coupled to a back portion 115. The door 114 includes a locking mechanism 116. During operation, the door 114 is locked. Typically, unlocking the door 116 causes the gaming machine 108 to enter a tilt mode where gaming functions, such as the play of a skill-based game, are not available. It should be appreciated that this tilt mode can be referred to as a hard tilt.

The cabinet 108 may include a number of apertures that allow access to a portion of a number of devices which are mounted to the cabinet 108. These gaming devices can include, but are not limited to a display 118, speaker 120, speaker 121, a printer 122, a bill acceptor 124, a secondary display 126, a card reader 128 and a button panel 130 including buttons 132 and 134. It should be appreciated that these gaming devices can be used to generate skill-based game play on the gaming machine 102.

In particular embodiments, the bill acceptor 124 may be used to accept currency or a printed ticket which can be used to deposit credits on the gaming machine 102. The credits may be used for playing the game and are stored in a credit meter. The printer 122 can be used to print tickets to transfer credits from the gaming machine 102. Typically, the tickets may be redeemed for cash or additional game play, such as game play on another gaming machine.

The bill acceptor 124 and printer 122 printer may be part of ticket-in/ticket-out (TITO) system (not shown). The TITO system may be included in the network services. The TITO system allows a ticket printed at a first gaming machine with a credit amount to be inserted into a bill acceptor at a second gaming machine and validated for game play. After validation, the credit amount associated with the ticket can be made available for game play on the second gaming machine.

The bill acceptor 124 may include a slot surround by a bezel which allows banknotes of various denominations or printed tickets to be inserted into the bill acceptor. The bill acceptor 124 may include sensors for reading information from the banknotes and determining whether the banknotes inserted through the slot are valid. Banknotes determined to be invalid, such as damaged or counterfeit notes, can be ejected from the bill acceptor 124. In some instances, the bill acceptor 124 may include upgradeable firmware and a network connection. It should be appreciated that via the network connection, new firmware, such as new counterfeit detection algorithms, can be downloaded to the bill acceptor 124.

The bill acceptor 124 includes mechanisms for guiding the banknotes or printed tickets past the internal sensors. Banknotes or printed tickets which are accepted can be guided to a bill stacker (not shown) located within the cabinet 108 of the gaming machine 102. It should be appreciated that the bill stacker can hold a maximum number of bank notes or printed tickets, such as up to two thousand.

The gaming machine 102 may include a sensor for detecting a fill level of the bill stacker. When the bill stacker is full or close to being full, the gaming machine 102 can be placed in a tilt mode. Next, the cabinet door 114 can be opened and the full bill stacker can be replaced with an empty one. Then, the door 114 can be closed and the gaming machine 102 can be restored to an operational mode in which it is available for game play.

One function of the printer 122 is to print “cash out” tickets. In a “cash out,” credits available on the gaming machine 102 may be transferred to an instrument, such as a printed ticket, or electronically transferred to an account for later access. Typically, a “cash out” can be initiated in response to pressing one of the physical buttons, such as 132 or 134, or touch screen button output on a display, such as display 118.

In one embodiment, the printer 122 may be a thermal printer. The printer can be loaded with a stack of tickets, such as a stack with two hundred, three hundred or four hundred tickets. Mechanisms in the printer 122 can grab tickets from the ticket stack and transport the tickets past the print heads for printing. It should be appreciated that the ticket stack may be located in an interior of the cabinet 108.

The printer 122 can include sensors for detecting paper jams and a status of the ticket stack. When a paper jam or low ticket stack is detected, the gaming machine 102 can enter a tilt mode where game play is suspended. In one embodiment, a tower light 105 can light to indicate the tilt status of the gaming machine 102. After the tilt condition is cleared, such as by clearing the paper jam or replenishing the ticket stack, the gaming machine 102 can enter an operational mode where game play is again available.

In particular embodiments, the printer 122 can be coupled to a gaming machine controller 123. The gaming machine controller 123 can be configured to send commands to the printer which cause a “cash out,” ticket to be generated. In addition, the printer 122 can be coupled to other systems, such as a player tracking system (not shown). When coupled to the player tracking system, commands may be sent to the printer 122 to output printed tickets redeemable for comps (comps refer to complimentary awards, such as but not limited to free credits, a free drink, a free meal or a free room) or printed coupons redeemable for discounts on goods and services.

In additional embodiments, a wireless interface 146 can be provided to generate the wireless connection 136. The wireless connection 136 may be established between the gaming machine 102 and the mobile device 106. The wireless connection 136 can be used to provide functions, such as, but not limited to, player tracking services, casino services (e.g., ordering drinks) and enhanced gaming features (e.g., displaying game play information on the mobile device). The wireless interface can be provided as a stand-alone unit or can be integrated into one of the devices, such as the bill/ticket acceptor 122 and the card reader 128. In addition, the bill/ticket acceptor 122 and the card reader 128 can each have separate wireless interfaces for interacting with the mobile device. In one embodiment, these wireless interfaces can be used with a wireless payment system, such as Apple Pay™ or Google Pay™. It should be appreciated that the wireless payment system can be used to transfer funds to the gaming machine that can be used for skill-based game play.

The door 114 can allow access an interior of the cabinet 108. Via this access, devices mounted to the cabinet, such as display 118, speaker 120, bill/ticket acceptor 122 or printer 124 can be serviced and maintained. For example, a receptor configured to receive currency and tickets, coupled to the bill acceptor, can be emptied. The receptor is often referred to as a bill stacker. In another example, blank tickets can be added to the printer 122 or paper jams can be cleared from the printer. When door 114 is opened, the gaming machine 102 can enter a hard tilt state where game play is disabled.

In addition, a number of devices (not shown) can be provided within the interior of the cabinet 108. A portion of these devices is not visible through an aperture in the cabinet 108. For example, a gaming machine controller (GMC) 123 which controls the play of an electronic card-based game on the gaming machine may be found within the cabinet 108. It should be appreciated that the gaming machine controller 123 is typically secured within a separate lockable enclosure (not shown).

As another example, a number of security sensors can be placed within the interior of the cabinet 108. The security sensors (not shown) can be configured to detect access to the interior of the gaming machine 102 For example, the sensors can be configured to detect when the locking mechanism 106 is actuated, the door 116 is opened or a locking mechanism associated with the enclosure for the gaming machine controller 123 is actuated. It should be appreciated that a power source, separate from an external power supply, such as a battery can be provided which allows the security sensors to operate and be monitored when the external power supply is not connected.

In particular embodiments, the cabinet 108 can have a sheet metal exterior designed to provide the rigidity needed to support top boxes and light kits as well as to provide a serious deterrent to forced entry. For example, the sheet metal can be sixteen gauge steel sheet. Additionally, the door, such as 114, can be backed with sheet steel in the areas around the displays. It should be appreciated that other materials, such as wood, wood composites, can be incorporated into the cabinet 108 and the example of sheet metal is provided for the purposes of illustration only.

A speaker, such as 120 or 121, can be protected by a metal screen. In one embodiment, the speaker 120 or 121 can be a subwoofer speaker. In general, a sound system associated with the gaming machine 102 can include an audio amplifier and one or more speakers of various types, such as subwoofers, midrange speakers and tweeters.

The displays 118, 112, and 126, the speakers 120 and 121, the printer 122, the bill acceptor 124, the card reader 128 and the button panel 130 can be used to generate a play of a skill-based game on the gaming machine 102. Further, the display 118 can include a touchscreen. The touchscreen can be used to provide inputs used to play the skill-based game and include a win meter. The skill-based games that can be played include, but are not limited to, electronic card games. The electronic card-based games are typically games of chance and utilize a random number generator (RNG) to determine an outcome to the game.

In general, the electronic card-based games can be classified as Class III games. Class III games can include, but are not limited to blackjack, baccarat, pai gow, poker, etc.

As described above, the electronic card-based game may be an electronic card game. In general, the electronic card game of the present invention has been named “PoQum™” and includes various PoQum™ game variants in which players have simple choices or selections to make in each game, and there is a skill component associated with each selection. Further, PoQum is a novel and simpler video-poker-style game. It may be presented either as in its new form (described below) or as a video poker variant.

### Game Play

Single deck. The game elements include a standard deck of fifty-two (52) cards. The deck may or may not have jokers, depending on the game variants. The game elements also include a stash area with placeholders for a number of cards. Typically, this area holds up to five cards. The game elements include a player hand area. This consists of the player's final hand, and it is filled with cards during the various stages of the game. The game elements include a pay table, which awards the player various prizes, depending on the final hand. The prizes consist of typical poker outcomes, for example, ROYAL FLUSH, STRAIGHT FLUSH, FOUR OF A KIND, FULL HOUSE, STRAIGHT THREE OF A KIND, various PAIRS, and so on.

The Game Play. The player commits a wager. The stash is filled with cards drawn randomly from the deck. The player decides how many more cards to draw from the remaining deck. Typically, this number is between zero and five. A number of cards equal to the player's decision above are drawn randomly from the remaining deck. These cards are placed directly on the player hand area, as they will be part of the player's final hand. The final hand is completed with the necessary number of cards selected from the stash, in a way that maximizes the pay for the poker outcome. The player is paid an award, if applicable. The game is reset by placing all the cards back in the deck.

Multi-Decks (Multi-hands): The game elements include several standard decks of fifty-two (52) cards. The decks may or may not have jokers, depending on the game variants. The game elements include a stash area with placeholders for a number of cards. Typically, this area holds up to five cards. The game elements include a player hands area. This consists of the player's final hands, one hand per active deck and it is filled with cards during the various stages of the game. The game elements include a pay table, which awards the player various prizes, depending on the final hand. The prizes consist of typical poker outcomes, for example, ROYAL FLUSH, STRAIGHT FLUSH, FOUR OF A KIND, FULL HOUSE, STRAIGHT THREE OF A KIND, various PAIRS, and so on.

The Game Play: The player commits a wager. The stash is filled with cards drawn randomly from the first deck. These cards are removed from all the remaining decks. The player decides how many more cards to draw from each of the remaining deck. The cards count is used for all the decks (there are no multiple choices). Typically, this number is between zero and five. A number of cards equal to the player's decision above are drawn randomly from each of the decks. These cards are placed directly on each player's hands area, as they will be part of the player's final hands. Each final hand is completed with the necessary number of cards selected from the stash, in a way that maximizes the pay for the poker outcome. The stash cards are reused for each hand independently. The player is paid an award, if applicable. The game is reset by placing all the cards back in the deck.

Multiple Decks (Multi-Hand): The game elements include several standard deck of fifty-two (52) cards. The decks may or may not have jokers, depending on the game variants. The game elements include a stash area with placeholders for a number of cards. Typically, this area holds up to five cards. The game elements include a player hands area. This consists of the player's final hands, one hand per active deck and it is filled with cards during the various stages of the game. The game elements include a pay table, which awards the player various prizes, depending on the final hand. The prizes consist of typical poker outcomes, for example, ROYAL FLUSH, STRAIGHT FLUSH, FOUR OF A KIND, FULL HOUSE, STRAIGHT THREE OF A KIND, various PAIRS, and so on.

The Game Play: The player commits a wager. The stash is filled with cards drawn randomly from the first deck. These cards are removed from all the remaining decks. The player decides how many more cards to draw from each of the remaining deck. The cards count is used for all the decks (there are no multiple choices). Typically, this number is between zero and five. A number of cards equal to the player's decision above are drawn randomly from each of the decks. These cards are placed directly on each player's hands area, as they will be part of the player's final hands. Each final hand is completed with the necessary number of cards selected from the stash, in a way that maximizes the pay for the poker outcome. The stash cards are reused for each hand independently. The player is paid an award, if applicable. The game is reset by placing all the cards back in the deck.

### Game Play Examples

One pay table similar to “double double bonus”, with a hit frequency of 15.5% and an RTP of 94.16% is as follows (pays are for 1 credit bet) is shown in FIG. 2. Three card decks are active. The player commits a wager of 1 credit. The stash is Ace (Diamonds), Ten (Hearts), 8 (Clubs), 8 (Spades), and 4 (Diamonds). The player decides to draw three cards (or keep two). The players' three hands are populated as follows with cards from the three independent decks: K (Diamonds), 8 (Hearts), and 4 (Clubs); 4 (Clubs), 4 (Spades), and 8 (Diamonds); 9 (Hearts) 3 (Clubs), and K (Spades). The final hands are: K (Diamonds), 8 (Hearts), 4 (Clubs), 8 (Clubs), and 8 (Spades)—THREE OF A KIND, pays 1 credit; 4 (Clubs), 4 (Spades), 8 (Diamonds), 8 (Clubs), and 8 (Spades)—FULL HOUSE, pays 5 credits; and 9 (Heart), 3 (Club), King (Spades), Ace (Diamonds) and Ten (Hearts)—NOTHING. The final total pay is 6 credits.

Example of a different pay table: A pay table with fewer, but higher awards, with a hit frequency of 7.8% and an RTP of 94.02% is shown in FIG. 3.

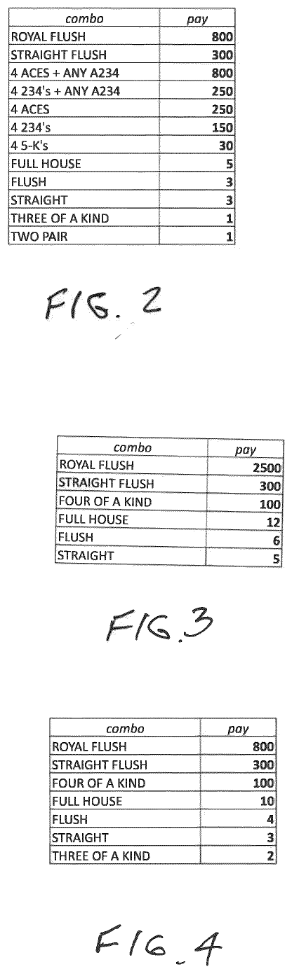

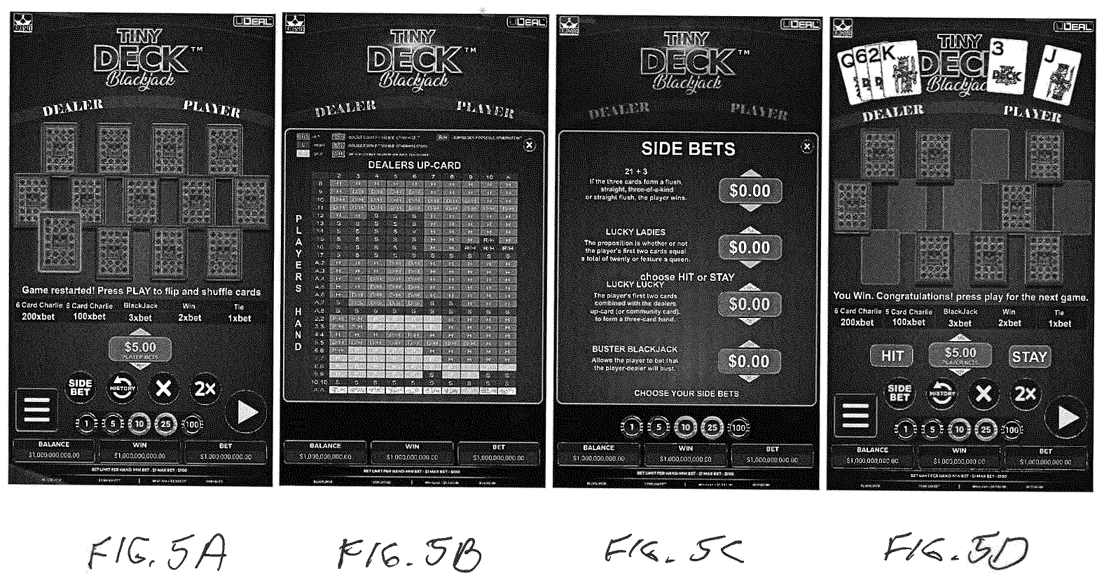

A compromise among the first two example is the following payable with a hit frequency of 17.7%, and an RTP of 94.13% is shown in FIG. 4.

Alternative Video Poker Game Play: The PoQum game mechanics can be seamlessly integrated as a “traditional” video poker. Normally this would be implemented as an additional side bet wager to enable the bonus, typically enabled at the maximum bet. The game play proceeds just as in standard video poker: the player decides which cards to hold. However, upon drawing the remaining cards from the remaining decks, the cards held in each instance are replaced, independently for each hand in play, with an equal number of the dealt cards so that the pay is maximized. This variant could be called “No Regrets Poker”. In all variants of the game, additional cards such as jokers or specific bonus cards such as Bonus I or Bonus 2 could be introduced to the deck to facilitate more or less volatile versions of the game.

### 13-Card Card Deck and Game Adaptions

The present invention also includes a new card deck composition and its applications for novel variations of popular card games. The present invention introduces a simplified deck of cards consisting of only thirteen unique ranks, eliminating traditional suits.

The card deck contains thirteen (13) cards: Ace, Two, Three, Four, Five, Six, Seven, Eight, Nine, Ten, Jack, Queen, and King. Suits (Hearts, Diamonds, Spades, Clubs) are absent. Removing suits reduces complexity, making games more accessible for casual players. Traditional card-counting strategies become inapplicable, necessitating new tactics in adapted games. This introduces a potential advantage for skilled players. The smaller card pool can increase the frequency of certain events or hands, heightening game excitement. It should be appreciated that the 13-card suit-less deck lends itself to unique variations of classic card games.

The electronic cards 103 in the 13-card suit-less deck are shuffled by the RNG and are dealt by player selection from the input device so that the player picks sequentially which cards are dealt to the dealer or player for Blackjack or Banker and Player for Baccarat. It should be appreciated that, when a player is facing an electronic deck of fifty-two (52) cards, dealing by picking is cumbersome while picking from only thirteen (13) electronic cards is simple. It should also be appreciated that decreasing the number of electronic cards to thirteen (13) actually decreases the frequency of combination which allows for higher odds and bigger payouts so it is a way to volatize the gaming experience.

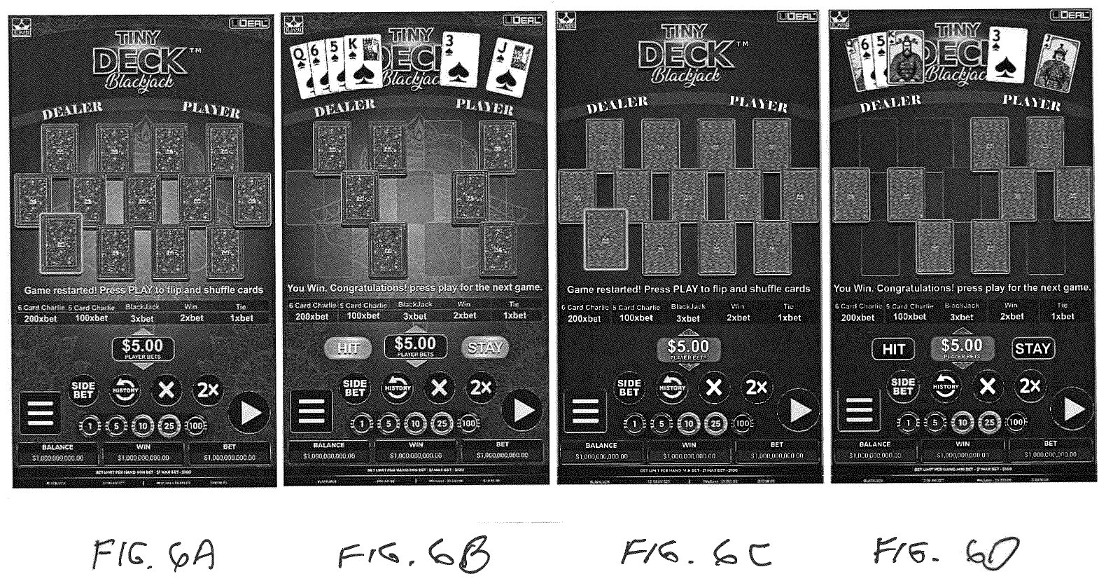

13-Card Blackjack: Core blackjack principles remain, but since there is only one Ace in play per game odds and awards related to Blackjack can be greatly increased. Since there are only 13 cards ever in play, the most popular side bet options for commercial casino blackjack deployments are no longer applicable. Introduction of “Charlie” side bets, where players win on hands of 5 or 6 cards without busting, adds a new layer of excitement and decision-making. An example of the 13-Card Blackjack is shown in FIGS. 5A-5D. An example of an alternate 13-Card Blackjack is shown in FIGS. 6A-6D.

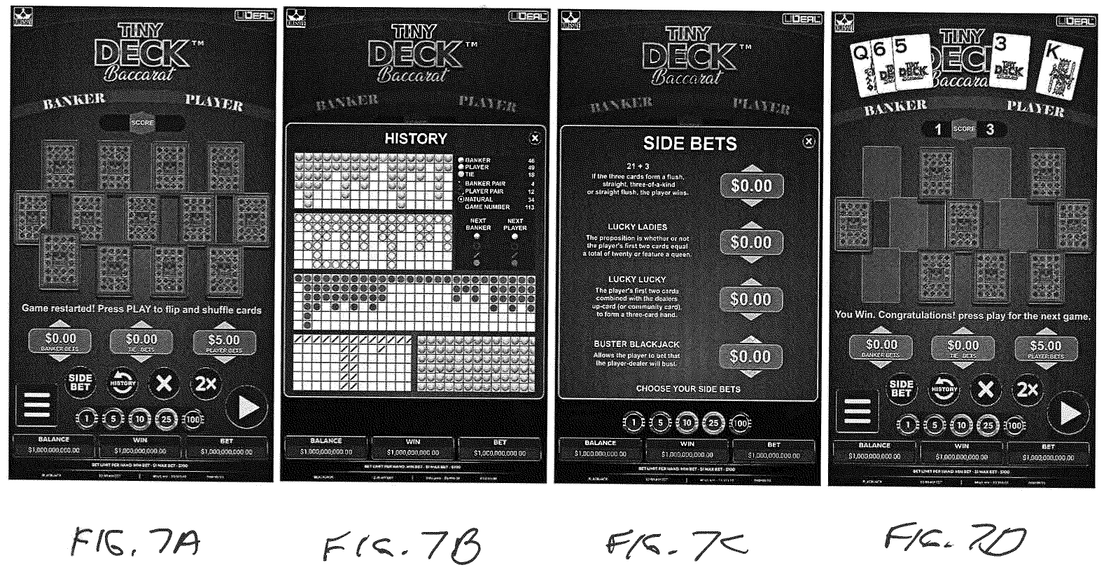

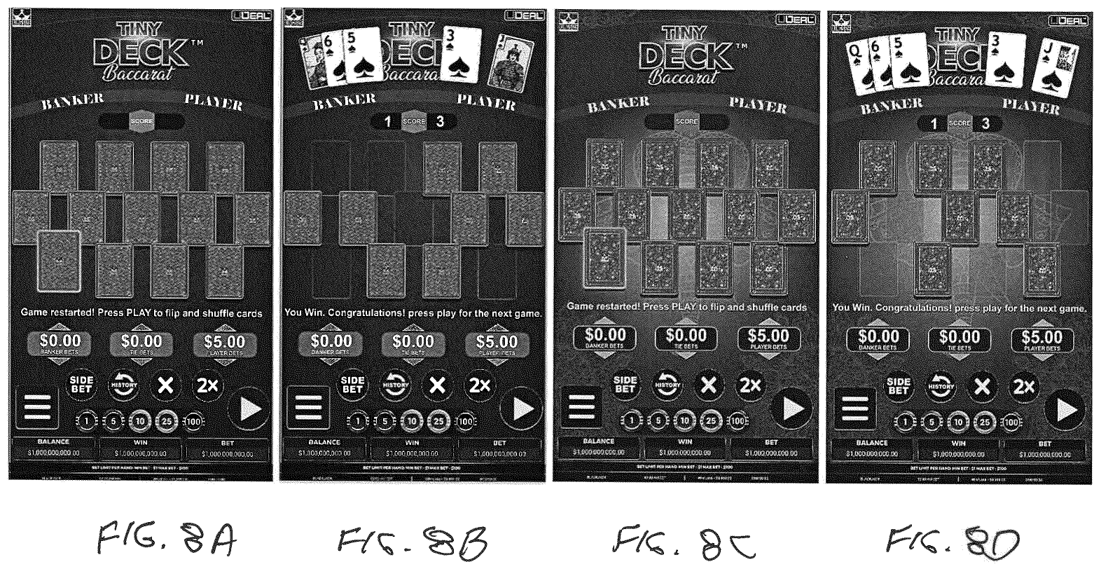

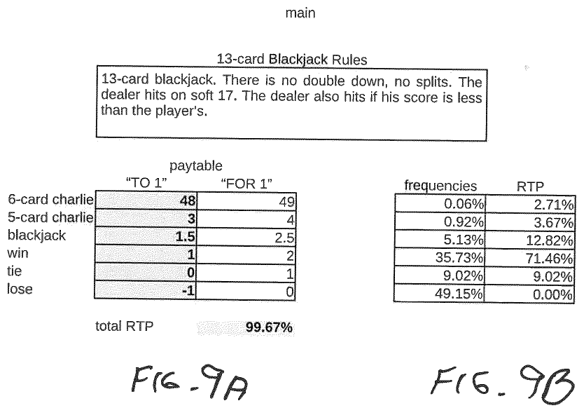

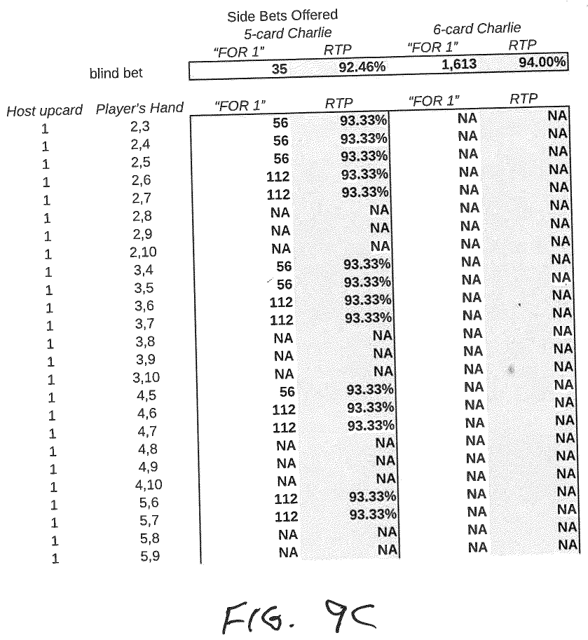

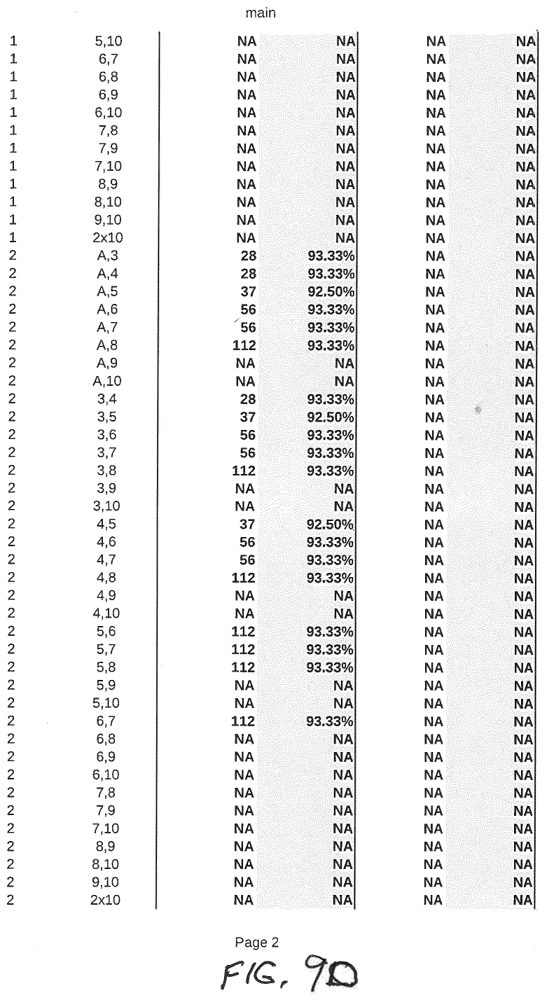

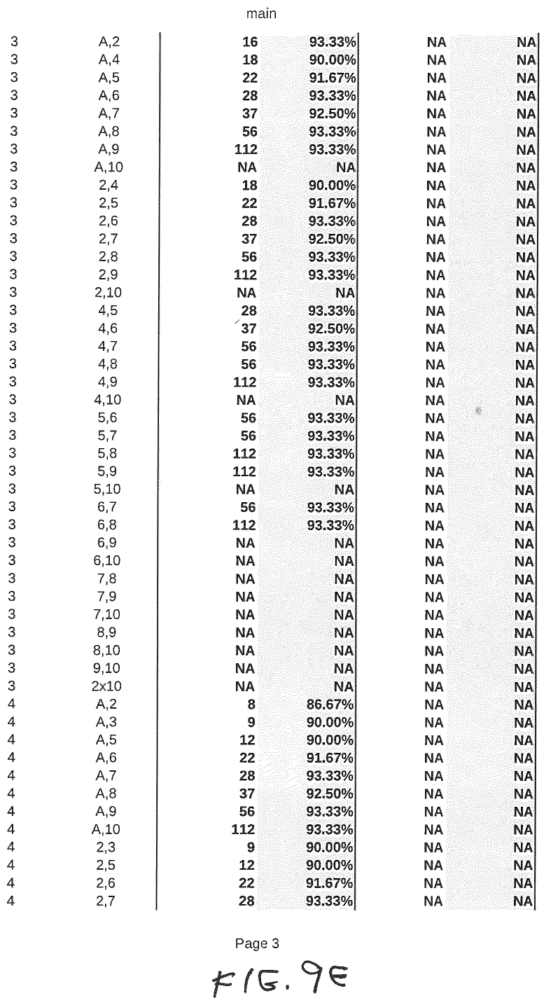

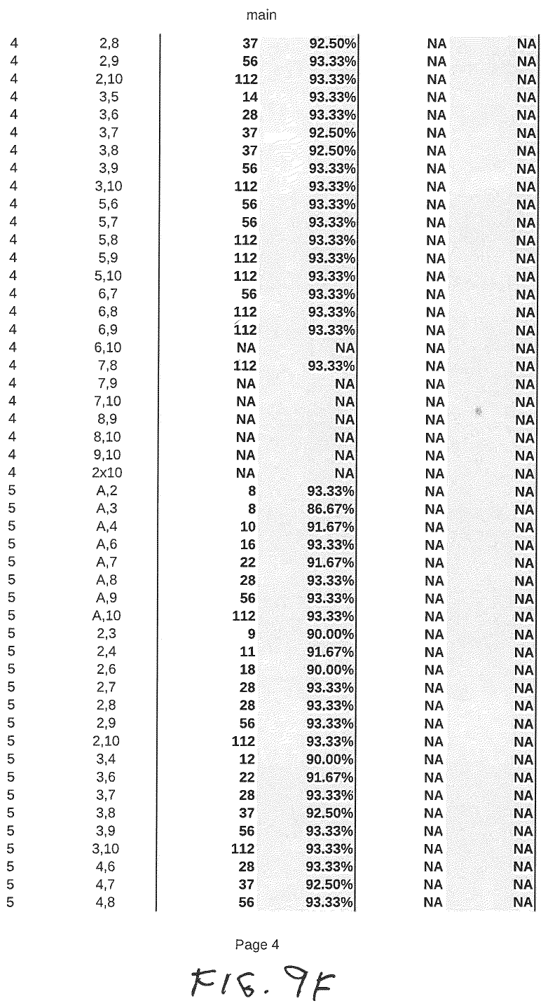

13-Card Baccarat: Traditional Baccarat can be dealt from a 13-card deck, but odds related to particular combinations change, allowing for new side bet options and for new ways to increase house edge which is traditionally relatively low for the game of Baccarat. A variant to Traditional Baccarat could be that Traditional betting on “Player” vs. “Banker” hands remains, but a single “community” card dealt face-up adds suspense and an element of shared fate. Removal of automatic third card rules streamlines gameplay and speeds up the pace and allows for new side bet and base game betting opportunities. An example of the 13-Card Baccarat is shown in FIGS. 7A-7D. An example of an alternate 13-Card Baccarat is shown in FIGS. 8A-8D.

13-Card Poker Variations: The suit-less deck limits traditional hand ranking but offers potential for new hand hierarchies (e.g., straights become more valuable). Simplified hand rankings could make these variations appeal to novice poker players.

### 13 Card Blackjack—One Sample Game Variant Overview

13-card blackjack with 5 and 6 card Charlies. The game uses a simplified deck of only 13 cards with no suits. The cards are Ace,2,3, 4, 5′6,7,8,9, 10, Jack, Queen, and King.

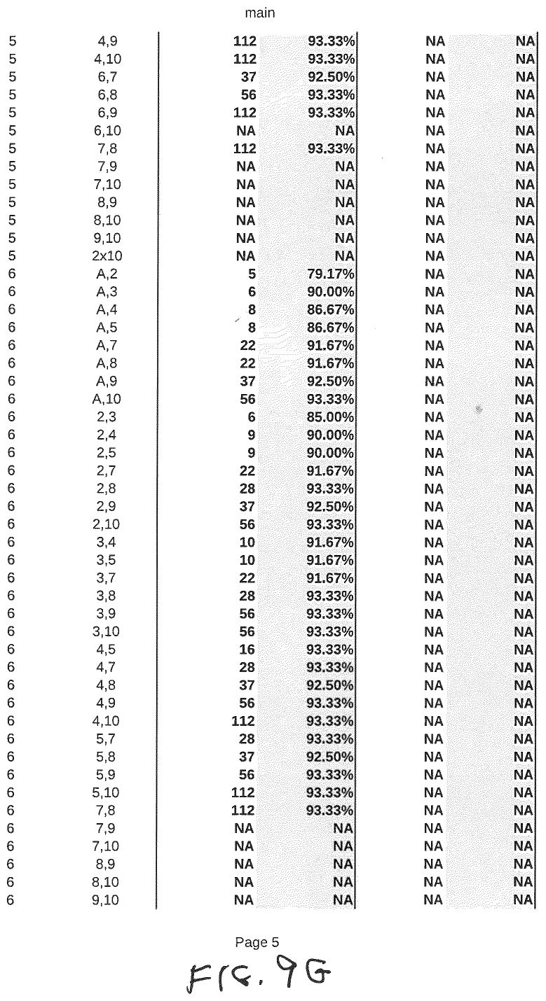

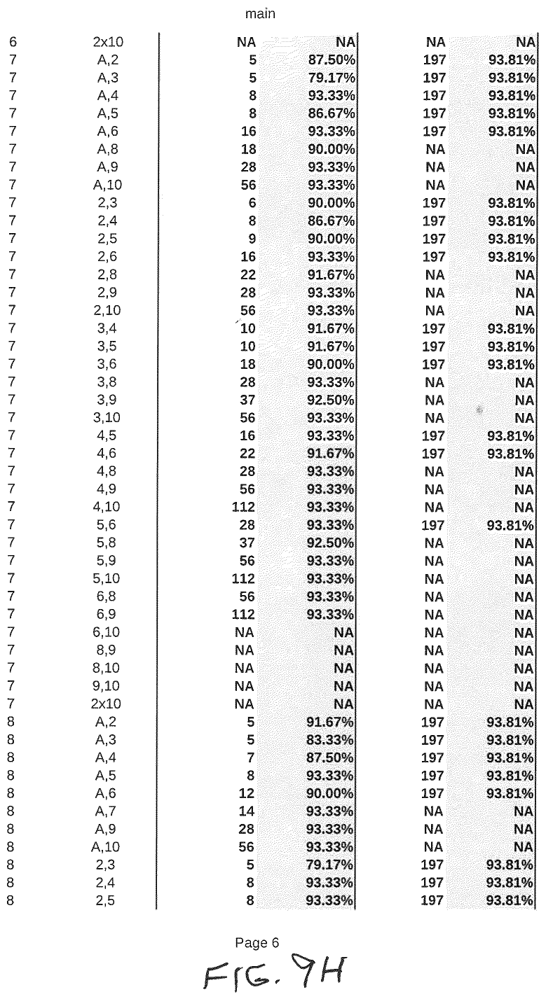

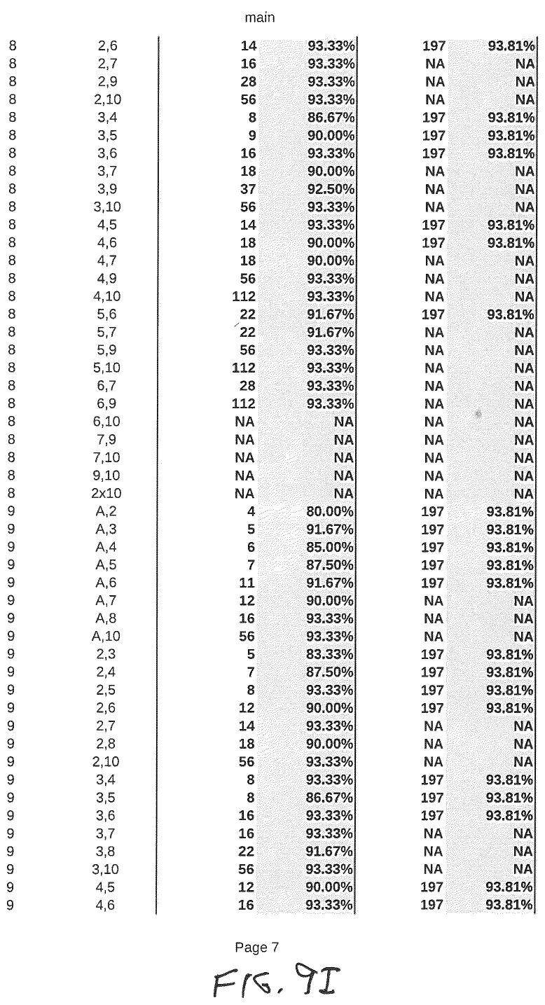

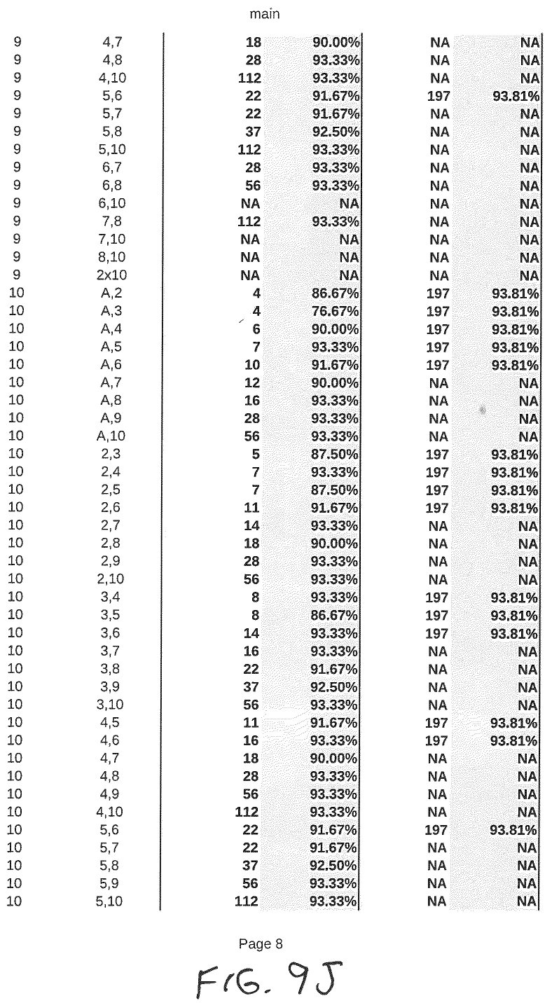

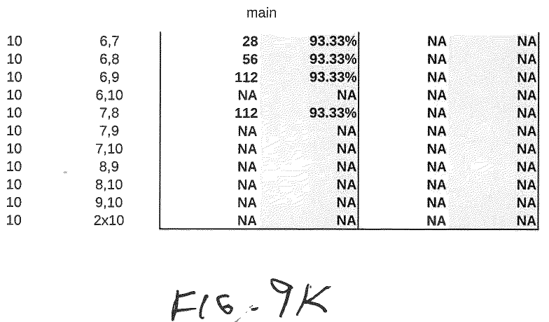

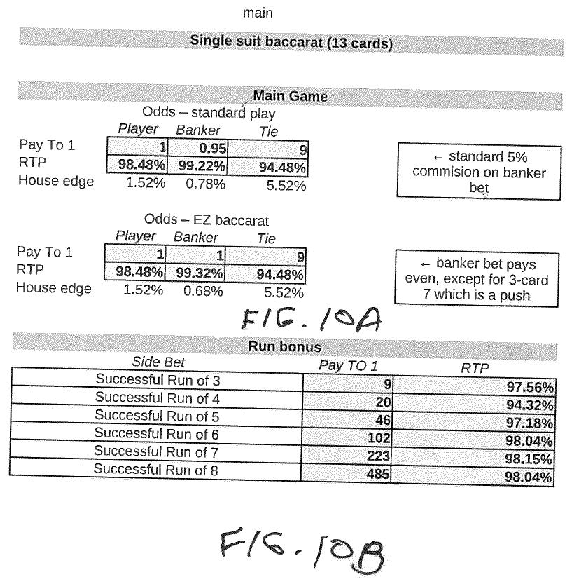

Gameplay Initial Deal: The player sees all 13 cards face-up. After placing an initial wager, the cards are shuffled and flipped face-down. The player then deals four cards by touching the card backs: the first goes to the player face-up, the second to the dealer face-up, the third to the player faceup, and the fourth to the dealer face-down. Player's Turn: The player can choose to “hit” (take another card) or “stand” (keep their hand). If the player's hand exceeds 21, they “bust” and automatically lose their initial wager. Blackjack: Due to their being only once Ace in play per game the odds and related awards to achieving a Blackjack are greatly increased resulting in a far more volatile version of Blackjack. Dealer's Turn: For 13 card Blackjack dealer popular rules can be kept in place as or they can be modified to accommodate new side bets or base game rules. Charlie Side Bets: One side bet option is that after the first 4 cards are dealt the player has the option to place one or two side bets on whether they will achieve a 5-card Charlie or a 6-card Charlie (hands of 5 or 6 cards without exceeding 21). Once side bets are placed the game continues. Charlie Resolution: If the player achieves a 5-card or 6-card Charlie, their side bets (if placed) are paid out. The dealer still plays out their hand, but a player win is guaranteed unless the dealer also achieves a qualifying Charlie. Charlie Dealer's Turn: After the player stands (or busts), the dealer's hidden card is revealed' Initial 17-21: If the dealer's first two cards total 17, 18, 19, 20, or 21, they must stand. Less than 17: If their total is less than 17, they must continue to hit until they beat the player's hand total or bust. An example of a paytable and RTP are shown in FIGS. 9A and 9B. An example of the Side Bets Offered for 5-Card Charlie and 6-Card Charlie are shown in FIGS. 9C-9K.

Possible Winning Conditions for Charlie game variants. 6-Card Charlie: Beats everything. A player and dealer can tie if both have 6-card Charlies. 5-Card Charlie: Beats everything except a 6-card Charlie. A player and dealer can tie if both have 5-card Charlies. Blackjack: Beats everything except Charlies. Higher Hand Total: If neither player has a Charlie or Blackjack, the hand total closest to 21 without exceeding it wins. Tie: In tie scenarios, the player's bet is returned (a “push”).

Base Game Pay Table. Player Loses: 0. Tie: Play Again All payouts are calculated based on the desired game RTP as shown in FIGS. 9A and 9B. Player Wins: W×wager. Blackjack: X×wager. 5-Card Charlie: Y×wager. 6-Card Charlie: Z×wager. Side Bet Pay Table 5-Card Charlie: Y×side bet; and 6-Card Charlie: Z×side bet.

13-Card Baccarat—One possible game variant is with single community card. 13-card Baccarat with single community card takes the core thrill of baccarat and injects a dose of simplicity with a suit-less deck. Players bet on which hand, “Player” or “Banker,” will be closer to a score of 9 without exceeding it. The game uses a single deck of 13 cards, eliminating suits: Ace, 2,3, 4, 5, 6,7,8, 9, 10, Jack, Queen, King.

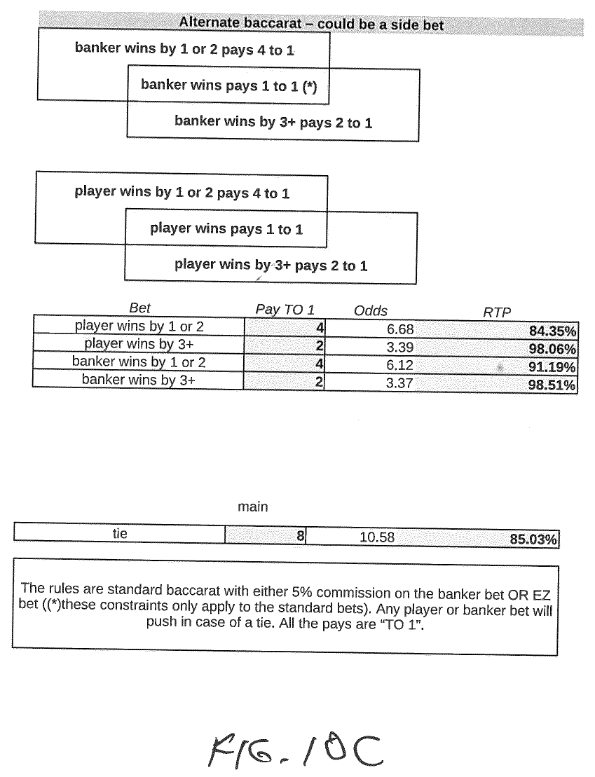

Gameplay: Betting: Players place their wagers on either the “Player” hand, the “Banker” hand, or a tic. Dealing: Two cards are dealt face-up: one to the “Player” hand and one to the “Banker” hand. Hand Values: Cards 2 through ten hold their face value. Face cards (Jack, Queen, King) are worth 0. Aces are worth 1. Third Card Rule: Unlike traditional baccarat, there's no automatic third card draw based on the initial hand totals. However, a single “community” card is dealt face-up after the initial two cards. This card is applied to both Player and Banker hands as needed based on traditional third card draw rules and ignored if not needed. Hand Totals: The final score is the units digit of the sum of the cards in each hand. For example, a hand with a 7 and a 5 would total 12, but the final score for baccarat would be 2. Winning Hand: The hand closest to 9 without exceeding it wins. In the case of a tie (both hands score the same), winning bets on the tic outcome are paid according to the pre-determined payout (typically 8:1). An exemplary view of a screenshot of the electronic card game with RTP, paytable for Run Bonus, and paytable for Alternate Baccarat that may be used with the system and gaming machine shown in FIG. 1 are shown in FIGS. 10A-10C.

Payouts: Payouts to be calculated based on 13 card deck and community card.

Additional Notes: The “community” card adds a layer of suspense and strategic consideration. Players can't predict which hand will benefit from it. The absence of automatic third card draws simplifies the game and speeds up the pace. Baccarat strategies based on card counting wouldn't be applicable in this version due to the single deck and limited number of cards. A further modification to the game of 13 card Baccarat could be the addition of an ante bet to offset the need for commission.

Odds can be implemented with an ante bet and removal of commission in 13-card baccarat, aiming for a theoretical slightly under 100% RTP to ensure a house edge: Ante Bet: This mandatory bet functions as the house's advantage, replacing the traditional commission on banker wins. Equalizing Probabilities: With fewer cards and no suits, the chances of a player win, banker win, and tie change slightly. New odds are calculated to offset these changes and support a favorable house edge.

Possible Payouts and Theoretical RTPs. This system uses a match-3 mechanic to replace or supplement traditional random number generators (dice, tard shuffles) in various games. Players strategically match elements on a grid to influence the outcome, adding an interactive layer to classic games. The following is a breakdown of how visual match-3 grids could be used for Craps, Horse Racing, and a sample Card Game:

### Match 3 Grids to Replace Dice, Cards, Horses, Teams, Roulette Wheels, etc.

Traditional live dealer gambling games rely heavily on manually generated random outcomes such as rolling or shaking dice, spinning roulette wheels, horses racing or shuffled cards being dealt. When converting live dealer type casino games to electronic or digital equivalents, random outcomes are usually derived from random number generators (RNGs) that replace outcomes that would traditionally have been generated by dice rolls, dealt cards, etc. Often players feel a disconnect with these electronically generated outcomes. The present invention introduces a novel approach: using match-3 mechanics to determine outcomes in popular games like horse racing, craps, and card games (Blackjack and Baccarat) roulette and others.

The Core Concept: A visually appealing grid replaces physical elements like dice or cards. Each grid square/tile represents a possible outcome in the game. Players strategically try to match these three of these squares/tiles to influence the outcome.

Benefits: Enhanced Player Engagement: Match-3 adds an interactive layer, allowing players to directly influence the game through their choices. Accessibility for New Players: The familiar match-3 mechanic presents a user-friendly alternative to complex rules or unfamiliar traditions. Strategic Depth: Player's luck and intuition form the basis of their picks and are directly tied to game results and their chances of winning. Customization: The system can be adapted to various games by adjusting the grid layout, symbols, and match mechanics. By integrating visual match-3 grids, this system offers a unique and engaging way to experience familiar games while keeping the strategic elements and excitement of classic gambling formats.

### EXAMPLES

Horse Racing: Grid: Each tile depicts a horse with varying numbers of tiles representing their odds (more tiles for favorites, fewer for underdogs). Gameplay: Players match tiles until they have matched 3 tiles to complete the required number of horses to correspond with their wages, the first 3 matching tiles represent the first horse across the finish line, the 2nd three represent the second horse, etc. Outcome: Once all picks are complete, a simulated race animation plays out based on the sequence of selected tiles until all the selected horses are shown to cross the finish line in the correct sequence. Payouts are then awarded based on final race order (win, place, show).

Craps: Grid: The grid showcases all possible dice roll combinations (2 through 12 or alternatively 2 sets of 1 to 6) with each outcome represented by a unique symbol. Three identical symbols represent each outcome, initially hidden. Gameplay: Players select squares on the grid. Matching three identical symbols (e.g., two squares with three pips or 3 squares with 1 pip and 3 squares with 2 pips) reveals the outcome 3 and triggers an animation simulating dice being rolled with that resulting number. Wager Resolution: All craps bets placed by players (Pass Line/Don't Pass, Come/Don't Come, Place Bets, etc.) are resolved based on the revealed outcome.

Card Games (Blackjack & Baccarat): Grid: The grid contains tiles representing card ranks (Ace, 2, 3, etc.) and suits (Hearts, Diamonds, Spades, Clubs). Three identical tiles represent each card value and suit combination. Gameplay: Players take turns matching tiles. Matching three tiles reveals a card (e.g., three tiles with the Queen of Spades symbol reveal a Queen of Spades card). Players continue matching tiles to build their hand or the dealer's hand. Outcome: Once all cards are revealed (based on tile matches), the game proceeds according to standard Blackjack or Baccarat rules. Winning hand values are determined, and payouts are awarded. By integrating match-3 mechanics, this system offers a unique and interactive twist on classic gambling games. It enhances player engagement, provides an innovative learning curve for inexperienced players, and maintains the strategic elements and excitement inherent in these games.

Benefits: Player Engagement: The match-3 element adds an interactive layer to classic games, allowing players to feel more involved in determining the outcome. Accessibility: This format can potentially be easier to learn for new players compared to traditional mechanics.

### Fraction Chip Wagers and Payouts for Traditional Table and Card Games by Replacing Traditional Chips with Virtual Credits

The present invention relates to table and card game enhancements enabled by creating game variants that accept fractional Chip or Virtual Credit wagers and payouts' When Bill Validators were introduced to slot machines they allowed slot machine manufacturers to completely revolutionize the type of slot games that had historically been designed. Up to that point, slot games were driven by coin or token denominations and wagers and payouts had to be tied to multiples of a particular coin or token. Bill validators allowed for wagers and payouts to be made in pennies or virtual credits and as a result game math instantly changed allowing for small wins and many more ways to win small wins in every game.

Historically, Table Games were bound by similar limitations to those of coin-based slot machines and even more since the complexity of table and card games were also constrained by a dealer's ability to quickly perform calculations and accurately manage physical chips, particularly in high-action environments. Making fractional chip payouts has always been not possible for a myriad of reasons. Today Live Dealer, Pavilion style gaming and Electronic Table Games have effectively removed the need for games to remain bound to denomination or value-based chips, but Table, Card and other Dealer based games have not been innovated to support partial chip, or penny or virtual credit wagers or payouts. The present invention refers to creating game variants of popular table and card games that are based on fractional chip or virtual credit wagers and payouts.

### EXAMPLES

Blackjack Fractional Payouts: Blackjack Bonus: A base bet wins 1:1, but a virtual credit system allows for fractional payouts for wins achieved with specific card combinations such as 1.5:1 for a win with 7-7-7). Insurance with Granular Payouts: Instead of a flat 2:1 payout, the system can offer variable payouts based on the dealer's up card (e.g., higher payout if the up card is an Ace or Ten).

Side Bets with Automatic Calculations: Specific Two-Card Totals: Players can wager on whether their first two cards will total a specific value (e.g., 12 or 13). Automatic calculations decide payouts based on pre-set odds.

‘Lucky Sevens” Side Bet: A wager on whether a specific number of Sevens will appear during the hand (including the dealer's cards). Fractional payouts are awarded based on the number of Sevens dealt.

Baccarat: Optional Fractional Payouts: Variable payouts based on the winning hand's margin of victory. Expanded Side Bets: Wagers on specific cards appearing and various pair-related side bets with fractional payouts.

The gaming machine controller 123 includes a processor, a memory device for storing program code or other data; a display as described above; and one or more input device interfaces. The gaming machine 102 may further include a sound output system having a sound card, speakers, headphone jack, and other means to drive sound output, one or more video cards configured to drive at least one display 118, and additional display units.

The processor is typically a microprocessor or microcontroller-based platform which is capable of displaying images on the display 118 of game symbols, creating and representationally displaying a game grid and game grid elements and various other components of the game. The memory device can include random access memory (RAM) for storing event data or other data generated or used during a particular game. The memory device can also include read only memory (ROM), or other non-transitory computer-readable media configured to store program code which controls the gaming machine 102 so it plays a particular game in accordance with applicable game rules and pay tables.

It should be appreciated that although a processor and memory devices are possible implementations, further embodiments can also be implemented using one or more application-specific integrated circuits (ASIC's) or other hard-wired devices, or using mechanical devices (collectively, and/or individually referred herein as a “processor”). Furthermore, although the processor and memory device in certain embodiments reside on each gaming machine 102, it is possible to provide some or all of their functions from an off-site device such as a network server for communication to a playing station such as over a local area network (LAN), wide area network (WAN), Internet connection, microwave link, and the like. The processor and memory device are generally referred to as a “computer” or “controller.”

Input devices, can include physical buttons and controllers such as joysticks, mice, keyboards, and similar game controllers. Further, an input device can include specialized devices such as a currency acceptor configured to relay the input of value to the processor. Examples can include devices that: take in bills or coins, read credit cards, take contactless payments, or any other means of taking an item of worth and conveying the value of the worth to the processor. Physical buttons may be symbolically represented on a display device configured to display input information. The display device may further be configured to directly accept input from a user, as in a touch screen device or infrared screen overlay device. In further embodiments, additional value data may be obtained from a networked device configured to obtain value data and provide it to a processor.

This written description uses examples to disclose the aspects of the present invention, including the best mode, and also to enable any person skilled in the art to practice the invention, including making and using any devices or systems and performing any incorporated methods.

Those skilled in the art will readily appreciate that the systems and methods described herein may be a standalone system or incorporated in an existing gaming system. The system of the present invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the present invention so long as players and operators thereof are provided with useful access thereto, either through a mobile device, gaming platform, or other computing platform via a local network or global telecommunication network.

Although specific features of various embodiments of the present invention may be shown in some drawings and not in others, this is for convenience only. In accordance with the principles of the present invention, any feature of a drawing may be referenced and/or claimed in combination with any feature of any other drawing.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. The terms used herein, such as modules like display module, betting module, award module, servers, like player account server, database server, etc. are for case in describing and illustrating features and operations of the present invention and are not to be considered limiting in any way. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the present invention illustrated and described herein is not essential, unless otherwise specified. That is, the operations described herein may be performed in any order, unless otherwise specified, and embodiments of the present invention may include additional or fewer operations than those disclosed herein. For example, it is contemplated that executing or performing a particular operation before, contemporaneously with, or after another operation is within the scope of aspects of the present invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle™ Database, MySQL, IBM™ DB2, Microsoft™ SQL Server, Sybase™, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N. Y.; Microsoft is a registered trademark of Microsoft Corporation, Redmond, Wash.; and Sybase is a registered trademark of Sybase, Dublin, Calif.).

This written description uses examples to disclose the present invention, including the best mode, and also to enable any person skilled in the art to practice the present invention, including making and using any devices or systems and performing any incorporated methods. The patentable scope of the present invention is defined by the claims, and may include other examples that occur to those skilled in the art. Other aspects and features of the present invention can be obtained from a study of the drawings, the disclosure, and the appended claims. The present invention may be practiced otherwise than as specifically described within the scope of the appended claims. It should also be appreciated, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing gaming system. The system of the present invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the present invention so long as players and operators thereof are provided with useful access thereto, either through a mobile device, gaming platform, or other computing platform via a local network or global telecommunication network.

Although specific features of various embodiments of the present invention may be shown in some drawings and not in others, this is for convenience only. In accordance with the principles of the present invention, any feature of a drawing may be referenced and/or claimed in combination with any feature of any other drawing.

What is claimed is:

1. A system for playing an electronic card game, said system comprising:
a gaming machine having a game display configured to display a plurality of electronic cards from a number of card decks of the electronic card game, at least one input device to provide an input, a credit meter, and a win meter;
a controller programed to display, on the game display, the electronic cards, and having a Random Number Generator (RNG), wherein the RNG calls are limited to a predetermined number of the electronic cards in a 13-card suit-less card deck; and
wherein the controller includes a processor to execute an algorithm of instructions to:
receive the input from the at least one input device;
presenting the predetermined number of the electronic cards on the game display, the predetermined number of electronic cards being determined by the RNG;
receiving an input from the at least one input device for an amount of credits and decreasing the amount of credits from a credit meter;
receiving a selection of one of the predetermined number of the electronic cards from the at least one input device;
revealing all of the predetermined number of the electronic cards on the game display; and
if a special electronic card or other winning outcome was selected, displaying by the win meter an award amount and crediting the credit meter with the award amount.

2. The system as set forth in claim 1 wherein the electronic cards are shuffled by the RNG and are dealt by the input from the at least one input device to pick sequentially which of the electronic cards are dealt.

3. The system as set forth in claim 1 wherein the electronic card game is a 13-card Blackjack game.

4. The system as set forth in claim 1 wherein the electronic card game is a 13-card Baccarat game.

5. The system as set forth in claim 1 wherein the electronic card game is a 13-card Poker game.

6. A gaming machine for playing an electronic card game comprising:
a game display configured to display a plurality of electronic cards of the electronic card game, at least one input device to provide an input, a credit meter, and a win meter;
a controller programed to display, on the game display, the electronic cards, and having a Random Number Generator (RNG), wherein the RNG calls are limited to a predetermined number of the electronic cards in a 13-card suit-less card deck; and
wherein the controller includes a processor to execute an algorithm of instructions to:
receive the input from the at least one input device;
presenting a predetermined number of the electronic cards on the game display, the predetermined number of electronic cards being determined by the RNG;
receiving an input from the at least one input device for an amount of credits and decreasing the amount of credits from a credit meter;
receiving a selection of one of the predetermined number of the electronic cards from the at least one input device;
revealing all of the predetermined number of the electronic cards on the game display; and
if a special electronic card or other winning outcome was selected, displaying by the win meter an award amount and crediting the credit meter with the award amount.

7. The gaming machine as set forth in claim 6 wherein the electronic cards are shuffled by the RNG and are dealt by the input from the at least one input device to pick sequentially which of the electronic cards are dealt.

8. The gaming machine as set forth in claim 6 wherein the electronic card game is a 13-card Blackjack game.

9. The gaming machine as set forth in claim 6 wherein the electronic card game is a 13-card Baccarat game.

10. The gaming machine as set forth in claim 6 wherein the electronic card game is a 13-card Poker game.

11. A control method of playing an electronic card game, said method comprising the steps of:
providing a gaming device having a game display configured to display a plurality of electronic cards of the electronic card game, at least one input device to provide an input, a credit meter, and a win meter;
programming a controller programed to display, on the game display, the electronic cards, and having a Random Number Generator (RNG) wherein the RNG calls are limited to a predetermined number of the electronic cards in a 13-card suit-less card deck; and
executing by a processor of the controller an algorithm of instructions to:
receive the input from the at least one input device;
presenting a predetermined number of the electronic cards on the game display, the predetermined number of electronic cards being determined by the RNG;
receiving an input from the at least one input device for an amount of credits and decreasing the amount of credits from a credit meter;
receiving a selection of one of the predetermined number of the electronic cards from the at least one input device;
revealing all of the predetermined number of the electronic cards on the game display; and
if a special electronic card or other winning outcome was selected, displaying by the win meter an award amount and crediting the credit meter with the award amount.

12. The control method of claim 11 including the step of shuffling the electronic cards by the RNG and dealing the electronic cards based on the input from the at least one input device to pick sequentially which of the electronic cards are dealt.

13. The control method of claim 11 wherein the electronic card game is a 13-card Blackjack game.

14. The control method of claim 11 wherein the electronic card game is a 13-card Baccarat game.

15. The control method of claim 11 wherein the electronic card game is a 13-card Poker game.
